(19) United States
(12) Patent Application Publication
(10) Pub. No.: US 2021/0042128 A1
(43) Pub. Date: Feb. 11, 2021

(54) INFORMATION PROCESSING SYSTEM, RELAY DEVICE, AND COMPUTER PROGRAM PRODUCT

(71) Applicant: FUJITSU CLIENT COMPUTING LIMITED, Kanagawa (JP)

(72) Inventors: Tomohiro Ishida, Kawasaki (JP); Masatoshi Kimura, Kawasaki (JP); Yuji Nakayama, Kawasaki (JP)

(73) Assignee: FUJITSU CLIENT COMPUTING LIMITED, Kanagawa (JP)

(21) Appl. No.: 16/893,085

(22) Filed: Jun. 4, 2020

(30) Foreign Application Priority Data
Aug. 9, 2019 (JP) 2019-147437

(51) Int. Cl. G06F 9/4401; G06F 13/36

(52) U.S. Cl. CPC G06F 9/4403; G06F 13/36

(57) ABSTRACT

An information processing system includes information processors and a relay device. Each of the information processors includes a first communication device to transmit a reset signal representing initialization and to transmit/receive data. The relay device includes an input device and a hardware processor. The input device receives the reset signal from each of the information processors with bypassing second communication devices of the relay device. When the input device receives the reset signal, the hardware processor executes initialization processing of initializing one of the second communication devices that corresponds to one of the information processors serving as a transmission source of the data. The initialization processing is executed on a condition that one of the information processors, from which the reset signal has been transmitted, receives the data via a connection device.

### CROSS-REFERENCE TO RELATED APPLICATIONS

This application is based upon and claims the benefit of priority from Japanese Patent Application No. 2019-147437, filed Aug. 9, 2019, the entire contents of which are incorporated herein by reference.

### FIELD

Embodiments described herein relate to an information processing system, a relay device, and a computer program product.

### BACKGROUND

A method of performing a parallel computation using a plurality of information processors has been known. For example, an information processing system has been proposed, which performs data communications between information processors through a relay device using an Ethernet (registered trademark) circuit or the like.

In such an information processing system, an information processor serving as a transmission destination is sometimes rebooted for some reason during communication between information processors. When the information processor serving as the transmission destination is rebooted, an information processor serving as a transmission source loses the transmission destination. As a result, a deadlock arises in some cases.

When it is detected, by periodically polling a register, that the information processor serving as the transmission destination is initialized due to a reboot thereof, the information processing system recovers from the deadlock by that the relay device executes a reboot.

However, in the case where a register is periodically polled to check whether a deadlock has been caused, a load is imposed on the information processing system. In the first place, it is desirable that no deadlock is caused. Therefore, there is a need for preventing the information processor serving as the transmission source from falling into a deadlock due to a reboot.

### SUMMARY

An information processing system according to a first aspect of the present disclosure includes: a plurality of information processors; and a relay device configured to communicably connect the information processors. Each of the information processors includes a first communication device configured to execute transmission of a reset signal representing that the corresponding information processor is initialized and to execute transmission and reception of data. The relay device includes: a plurality of second communication devices each provided for a corresponding one of the information processors and each configured to execute reception of the reset signal and to execute transmission and reception of the data; a connection device configured to connect the second communication devices to enable the data to be transferred; an input device configured to receive an input of the reset signal from each of the information processors with bypassing the second communication devices; and a hardware processor configured to, when the input device receives the reset signal, execute initialization processing of initializing one of the second communication devices that corresponds to one of the information processors serving as a transmission source of the data, the initialization processing being executed on a condition that one of the information processors, from which the reset signal has been transmitted, receives the data via the connection device.

A relay device according to a second aspect of the present disclosure is a device for communicably connecting a plurality of information processors. The relay device includes: a plurality of second communication devices each provided for a corresponding one of the information processors and each configured to execute reception of a reset signal representing that the corresponding information processors is initialized and to execute transmission and reception of data; a connection device configured to connect the second communication devices to enable the data to be transferred; an input device configured to receive an input of the reset signal from each of the information processors with bypassing the second communication devices; and a hardware processor configured to, when the input device receives the reset signal, execute initialization processing of initializing one of the second communication devices that corresponds to one of the information processors serving as a transmission source of the data, the initialization processing being executed on a condition that one of the information processors, from which the reset signal has been transmitted, receives the data via the connection device.

A computer program product according to a third aspect of the present disclosure includes a non-transitory computer-readable recording medium on which an executable program is recorded. The program is executed by a computer as a relay device that includes: a plurality of second communication devices each provided for a corresponding one of information processors and each configured to execute reception of the reset signal and to execute transmission and reception of the data; a connection device configured to connect the second communication devices to enable the data to be transferred; and an input device configured to receive an input of the reset signal from each of the information processors with bypassing the second communication devices. The program instructs the computer to, when the input device receives the reset signal, execute initialization processing of initializing one of the second communication devices that corresponds to one of the information processors serving as a transmission source of the data, the initialization processing being executed on a condition that one of the information processors, from which the reset signal has been transmitted, receives the data via the connection device.

### BRIEF DESCRIPTION OF THE DRAWINGS

FIG. 1 is a diagram illustrating an example of a whole configuration of a distributed computer according to one or more embodiments;

FIG. 2 is a diagram for describing an example of communication processing between platforms in the distributed computer according to one or more embodiments;

FIG. 3 is a diagram for describing a hardware configuration of the distributed computer according to one or more embodiments; and

FIG. 4 is a sequence diagram illustrating an example of restoration processing according to one or more embodiments.

### DETAILED DESCRIPTION

The information processing system, the relay device, and the computer program product according to the present disclosure are capable of preventing a deadlock due to a reboot.

Hereinafter, embodiments of the information processing system, the relay device, and the computer program product according to the present disclosure will be described in detail with reference to the drawings. Note that the present disclosure is not limited by one or more embodiments.

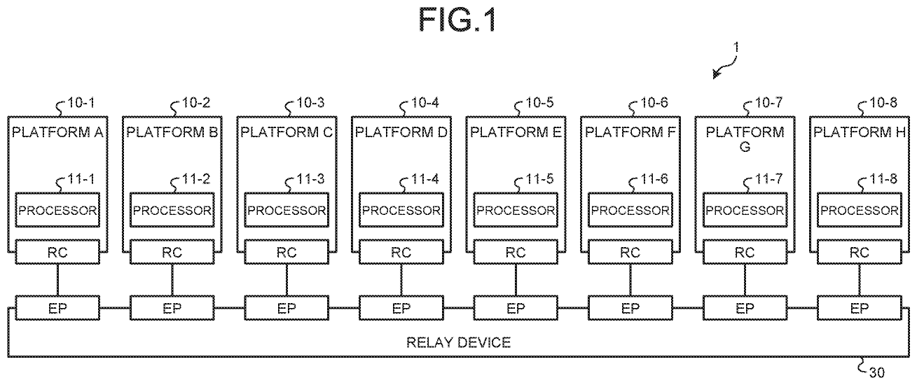

FIG. 1 is a diagram illustrating an example of a whole configuration of a distributed computer 1 according to one or more embodiments. The distributed computer 1 is an information processing system including a plurality of platforms A 10-1 to H 10-8 and a relay device 30 communicably connecting the platforms A 10-1 to H 10-8. As illustrated in FIG. 1, the distributed computer 1 according to one or more embodiments includes the platforms A 10-1 to H 10-8 and the relay device 30.

The platforms A 10-1 to H 10-8 are communicably connected to each other via the relay device 30. The platforms A 10-1 to H 10-8 are inserted into, for example, slots on a board provided with the relay device 30. Some of the slots may be empty in which no platform 10 is inserted. In the following description, when it is not necessary to distinguish among the platforms A 10-1 to H 10-8, any of the platforms A 10-1 to H 10-8 is expressed as a platform 10.

The platform A 10-1 is a main information processor that manages the platforms B 10-2 to H 10-8 and causes the platforms B 10-2 to H 10-8 to execute various types of processing.

Each of the platforms B 10-2 to H 10-8 is a sub-information-processor that executes processing, such as artificial intelligence (AI) inference processing or image processing, based on a request from the platform A 10-1.

The platforms A 10-1 to H 10-8 include processors 11-1 to 11-8, respectively. The processors 11-1 to 11-8 may differ in architecture. Furthermore, the processors 11-1 to 11-8 may be provided by different manufacturers or may be provided by the same manufacturer. In the following description, when it is not necessary to distinguish among the processors 11-1 to 11-8, any of the processors 11-1 to 11-8 is expressed as a processor 11.

The processor 11 controls the entirety of the platform 10. The processor 11 may be a multiprocessor. Alternatively, the processor 11 may be any one of, for example, a central processing unit (CPU), a micro processing unit (MPU), a graphics processing unit (GPU), a digital signal processor (DSP), an application specific integrated circuit (ASIC), a programmable logic device (PLD), and a field programmable gate array (FPGA). Alternatively, the processor 11 may be a combination of two or more constituents of a CPU, an MPU, a GPU, a DSP, an ASIC, a PLD, and an FPGA.

The platform 10 has a function as a root complex (RC) that is capable of operating as a host.

The relay device 30 includes a plurality of end points (EP). The relay device 30 relays communications over a bus between the platforms 10 each having a root complex connected to a corresponding one of the end points. Furthermore, the relay device 30 functions as the end points each including, for example, a slot and an address translation unit (ATU) connected to a corresponding one of the platforms 10. The root complexes and the end points may be, for example, peripheral component interconnect express (PCIe) root complexes and PCIe end points. By this configuration, data transfer is performed between the platforms 10 and the relay device 30.

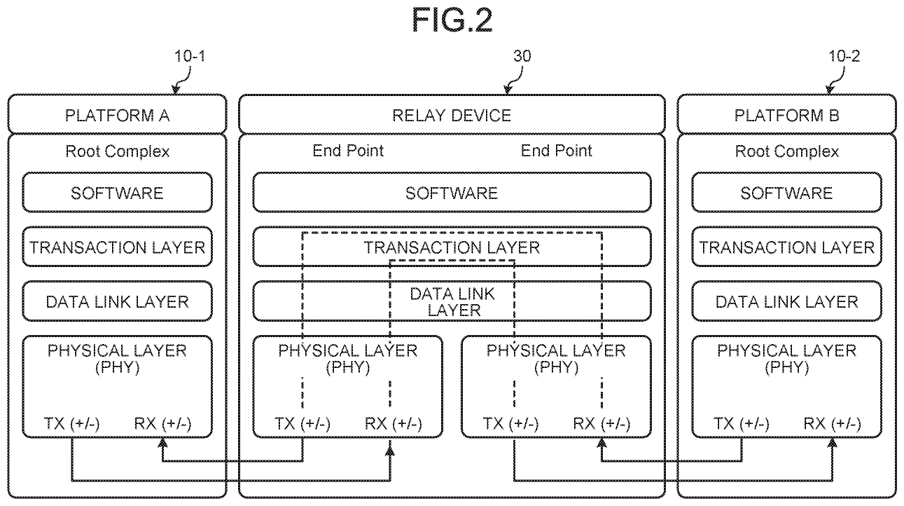

Next, a description is given of an example of communication processing between the platform A 10-1 and the platform B 10-2, which are connected to the relay device 30. FIG. 2 is a diagram for describing an example of communication processing between the platforms 10 in the distributed computer 1 according to one or more embodiments. While a description is given of an example of communication processing between the platform A 10-1 and the platform B 10-2, communications between other platforms 10 are performed in the same manner.

As illustrated in FIG. 2, the distributed computer 1 has a layered structure specified by, for example, a PCIe standard. Then, the distributed computer 1 performs communications between the platforms 10 through the layers.

The platform A 10-1 serving as a transmission source transfers data specified by a software program, through a transaction layer, a data link layer, and a physical layer (PHY) of the platform A 10-1, to a physical layer (PHY) of the relay device 30.

The relay device 30 delivers the data transferred from the platform A 10-1 serving as the transmission source to a transaction layer through the physical layer (PHY) and a data link layer. In the transaction layer, the relay device 30 transfers the data to an end point corresponding to the platform B 10-2 serving as a transmission destination by tunneling. The relay device 30 transfers the data, through the transaction layer, the data link layer, and the physical layer (PHY) of the relay device 30, to a physical layer (PHY) of the platform B 10-2 serving as the transmission destination. Accordingly, by the tunneling of the data between the end points, the relay device 30 transfers the data from the platform A 10-1 serving as the transmission source to the platform B 10-2 serving as the transmission destination.

In the platform B 10-2 serving as the transmission destination, the data are delivered to a software program through the physical layer (PHY), a data link layer, and a transaction layer.

In a case where data transfer does not center on only one of the platforms 10 connected to the relay device 30, data can be transferred in parallel between different random combinations of the platforms 10.

For example, in a case where both the platforms B 10-2 and C 10-3 communicate with the platform A 10-1, the relay device 30 performs communications with the platform B 10-2 and the platform C 10-3 by serial processing. In contrast, in a case where different platforms 10 communicate with each other and communications do not center on a specific one of the platforms 10, the relay device 30 performs communications between the platforms 10 by parallel processing.

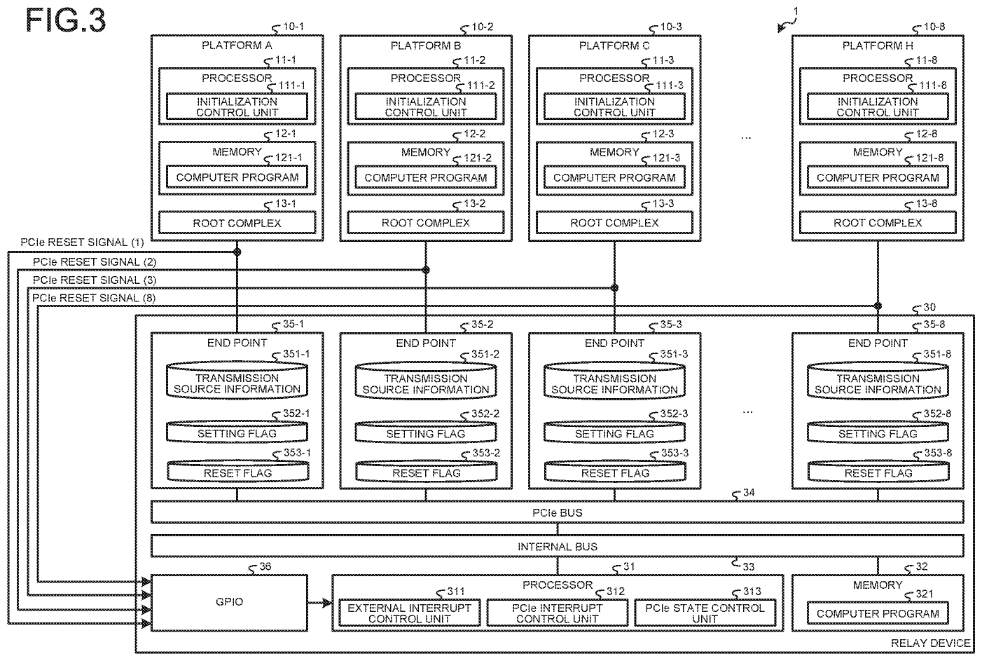

Next, a description of a configuration of the distributed computer 1 will be given. FIG. 3 is a diagram for describing a hardware configuration of the distributed computer 1 according to one or more embodiments.

First, a description of the platform 10 will be given. Here, the platform A 10-1 is taken as an example for the description. The platforms B 10-2 to H 10-8 are provided with the same hardware and information as those of the platform A 10-1.

The platform A 10-1 includes a processor 11-1, a memory 12-1, and a root complex 13-1. In the following description, when it is not necessary to distinguish among memories 12-1 to 12-8, any of the memories 12-1 to 12-8 is expressed as a memory 12. Furthermore, when it is not necessary to distinguish among root complexes 13-1 to 13-8, any of the root complexes 13-1 to 13-8 is expressed as a root complex 13.

The memory 12 is a storage device including a read only memory (ROM) and a random access memory (RAM). Various software programs and data for the software programs are written to the ROM. A computer program 121-1 stored in the memory 12-1 is loaded into the processor 11-1 and is executed. The RAM is used as a working memory. In the following description, when it is not necessary to distinguish among computer programs 121-1 to 121-8, any of the computer programs 121-1 to 121-8 is expressed as a computer program 121.

The processor 11-1 executes the computer program 121-1 stored in the memory 12-1 to implement a function illustrated in FIG. 3. Specifically, the processor 11-1 includes an initialization control unit 111-1 as a functional unit. In the following description, when it is not necessary to distinguish among initialization control units 111-1 to 111-8, any of the initialization control units 111-1 to 111-8 is expressed as an initialization control unit 111.

The initialization control unit 111 controls initialization of the platform 10. For example, the initialization control unit 111 initializes the platform 10 due to a reboot of the platform 10.

The root complex 13 is an example of a first communication unit (a first communication device). The root complex 13 controls communications of the platforms 10. For example, the root complex 13 transmits a PCIe reset signal representing that the corresponding platform 10 is initialized, and transmits and receives data. More specifically, when instructed by the processor 11 to transmit data, the root complex 13 transmits the specified data to the relay device 30. In this way, a platform 10 transmits data to another platform 10. When data from the relay device 30 is received, the root complex 13 notifies the processor 11 of the received data. In this way, a platform 10 receives data from another platform 10.

When the initialization control unit 111 initializes the platform 10, the root complex 13 transmits, to the relay device 30, a PCIe reset signal representing that this platform 10 has been initialized at a hardware level.

Next, a description of the relay device 30 will be given. The relay device 30 includes a processor 31, a memory 32, an internal bus 33, a PCIe bus 34, end points 35-1 to 35-8 each provided for a corresponding one of the platforms 10, and a general purpose input-output (GPIO) 36. In the following description, when it is not necessary to distinguish among the end points 35-1 to 35-8, any of the end points 35-1 to 35-8 is expressed as an end point 35.

The processor 31 controls the entirety of the relay device 30. The processor 31 may be a multiprocessor. Alternatively, the processor 31 may be, for example, any one of a CPU, an MPU, a GPU, a DSP, an ASIC, a PLD, and an FPGA. Alternatively, the processor 31 may be a combination of two or more constituents of the CPU, the MPU, the GPU, the DSP, the ASIC, the PLD, and the FPGA.

The memory 32 is a storage device including a ROM and a RAM. Various software programs and data for these software programs are written to the ROM. A computer program 321 stored in the memory 32 is loaded into the processor 31 and is executed. The RAM is used as a working memory.

The internal bus 33 communicably connects the processor 31, the memory 32, and the PCIe bus 34.

The PCIe bus 34 is an example of a connection unit (a connection device). The PCIe bus 34 communicably connects the end points 35 and the internal bus 33. In other words, the end points 35 are connected over the PCIe bus 34 to enable data to be transferred between them. Furthermore, the PCIe bus 34 is a bus conforming to the PCIe standard, for example.

The end point 35 is an example of a second communication unit (a second communication device). Each of the end points 35 is provided for a corresponding one of the platforms 10. Each end point 35 receives a PCIe reset signal, and transmits and receives data. For example, when data from the platform 10 connected to the end point 35 is received, the end point 35 transmits the received data over the PCIe bus 34 to another end point 35 connected to another platform 10 serving as a transmission destination. The relay device 30 transmits the data to another platform 10 by DMA (Direct Memory Access) transfer. When the end point 35 receives data over the PCIe bus 34 from another end point 35 connected to a platform 10 serving as a transmission source of the data, the end point 35 transmits the received data to a platform 10 connected thereto.

The end point 35-1 stores transmission source information 351-1. When it is not necessary to distinguish among transmission source information 351-1 to 351-8, any of the transmission source information 351-1 to 351-8 is expressed as transmission source information 351. More specifically, the end point 35 stores, in a DMA register used for DMA transfer between the end points 35, the transmission source information 351 representing a transmission source of data.

Furthermore, the end point 35-1 receives a PCIe reset signal from the platform 10-1 connected to the end point 35-1. The end point 35-1 has a setting flag 352-1 and a reset flag 353-1. In the following description, when it is not necessary to distinguish among setting flags 352-1 to 352-8, any of the setting flags 352-1 to 352-8 is expressed as a setting flag 352. Furthermore, when it is not necessary to distinguish among reset flags 353-1 to 353-8, any of the reset flags 353-1 to 353-8 is expressed as a reset flag 353.

The setting flag 352 is a flag for making the reset flag 353 effective or not effective when a PCIe reset signal is received. In one or more embodiments, the setting flag 352 is fixed at a setting that makes the reset flag 353 effective.

The reset flag 353 is a flag that is made effective by the setting flag 352 upon reception of a PCIe reset signal. In one or more embodiments, the setting flag 352 is fixed at a setting that makes the reset flag 353 effective upon the reception of a PCIe reset signal. Thus, the end point 35 makes the reset flag 353 effective upon the reception of a PCIe reset signal.

The GPIO 36 is an example of an input unit (an input device). The GPIO 36 receives an input of a PCIe reset signal from each of the platforms 10 with bypassing the end point 35. Then, the GPIO 36 notifies the processor 31 that the platform 10 has been initialized. More specifically, when a PCIe reset signal is received, the GPIO 36 outputs an external interrupt signal to the processor 31. After outputting the external interrupt signal, the GPIO 36 outputs a PCIe interrupt signal. In this way, the processor 31 is able to detect the initialization of the platform 10 via the GPIO 36. Therefore, it is not necessary for the processor 31 to perform polling over the internal bus 33 and the PCIe bus 34 in order to monitor whether the platform 10 has been initialized.

The processor 31 executes the computer program 321 stored in the memory 32 to implement a function illustrated in FIG. 3. Specifically, the processor 31 includes, as functional units, an external interrupt control unit 311, a PCIe interrupt control unit 312, and a PCIe state control unit 313. The processor 31 is an example of a control unit (a hardware processor).

The external interrupt control unit 311 executes external interrupt processing when an external interrupt signal is input. More specifically, when the GPIO 36 receives a PCIe reset signal, the external interrupt control unit 311 inhibits the external interrupt processing. Since a PCIe reset signal is generally unstable, there is a possibility that the external interrupt processing is caused more frequently than necessary. Therefore, the external interrupt control unit 311 inhibits the external interrupt processing. Furthermore, after a lapse of a predetermined period of time subsequent to the inhibition of the external interruption, the external interrupt control unit 311 clears the external interrupt processing.

The PCIe interrupt control unit 312 executes processing when a PCIe interrupt signal arises. The PCIe interrupt control unit 312 issues a restart signal. More specifically, the PCIe interrupt control unit 312 makes a request for reinitialization of the physical layer (PHY) of the end point 35 connected to the initialized platform 10. The PCIe interrupt signal arises after the external interrupt control unit 311 inhibits external interruption. As long as the time after the external interrupt control unit 311 inhibits external interruption, the PCIe interrupt signal may be arisen either after or before the external interrupt control unit 311 clears the external interrupt processing.

In the reinitialization of the physical layer (PHY) of the end point 35 connected to the initialized platform 10, the PCIe interrupt control unit 312 identifies the initialized platform 10, based on, for example, identification information contained in a PCIe interrupt signal. Note that, when a PCIe interrupt signal is input, the PCIe interrupt control unit 312 may acquire identification information for identifying the initialized platform 10, from the GPIO 36, the end point 35, the platform 10, or other blocks.

The PCIe interrupt control unit 312 acquires transmission source information 351 from the end point 35. More specifically, when a PCIe interrupt signal arises due to a PCIe reset signal, the PCIe interrupt control unit 312 acquires transmission source information 351 from each of the end points 35. Then, based on the transmission source information 351 acquired from each of the end points 35, the PCIe interrupt control unit 312 identifies which of the end points 35 has transmitted data to the initialized platform 10 by DMA transfer. Note that, in a case where the end point 35 connected to the initialized platform 10 stores transmission source information 351 representing a transmission source having transmitted data to the end point 35, the PCIe interrupt control unit 312 may acquire the transmission source information 351 from the end point 35 connected to the initialized platform 10.

The PCIe state control unit 313 monitors and manages end points 35. When the GPIO 36 receives a PCIe reset signal, the PCIe state control unit 313 executes initialization processing of initializing the end point 35 corresponding to the platform 10 serving as a transmission source of data. The initialization processing is executed on a condition that the platform 10, from which the PCIe reset signal was transmitted, receives data over the PCIe bus 34.

More specifically, in the initialization processing, when the PCIe state control unit 313 receives a PCIe interrupt signal from the GPIO 36 in a state where each thread of the platform 10 and the end point 35 is in a connected state, the PCIe state control unit 313 determines whether data is being transmitted to the platform 10 serving as a transmission destination. When data is being transmitted, the PCIe state control unit 313 initializes again the end point 35 corresponding to the platform 10 serving as a transmission source of the data.

The PCIe state control unit 313 executes initialization processing including a process of causing the platform 10 as a transmission source to stop the transmission of data. In other words, the PCIe state control unit 313 stops communications between the platform 10 serving as a transmission source and the end point 35 connected to the platform 10 serving as the transmission source. For example, the PCIe state control unit 313 stops DMA transfer performed between the platform 10 serving as a transmission source and the end point 35 connected to the platform 10 serving as the transmission source. By stopping communications before the platform 10 serving as a transmission source falls into a deadlock, the PCIe state control unit 313 prevents the platform 10 as the transmission source from falling into a deadlock. Furthermore, the PCIe state control unit 313 prevents a state where the end point 35 unintentionally receives data and thereby enters an unintended state.

The PCIe state control unit 313 brings a thread between the platform 10 and the end point 35 into a not-connected state, that is, a disconnected state. Note that the order of the initialization of the end point 35 and the stop of data transfer may be reversed. The end point 35 is brought into the not-connected state, and then returns to a connected state in accordance with a usual flow.

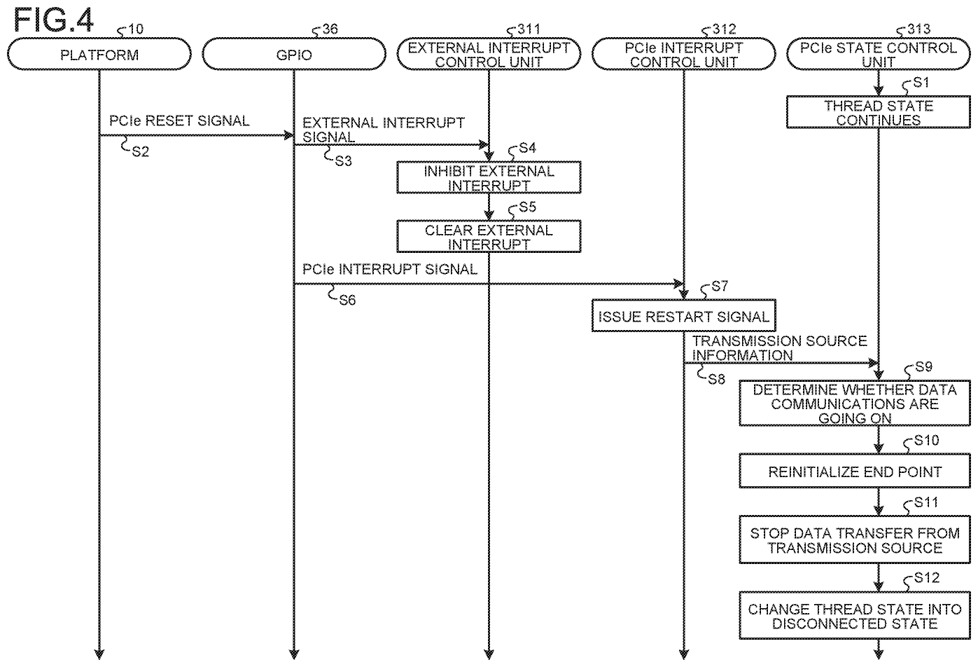

Next, a description of restoration processing using the distributed computer 1 will be given. FIG. 4 is a sequence diagram illustrating an example of restoration processing according to one or more embodiments. The restoration processing is executed in such a manner that, when the platform 10 serving as a transmission destination of data is initialized due to a reboot during data communications between the platforms 10, the platform 10 is restored to make data communications possible again without causing the platform 10 serving as a transmission source of the data to fall into a deadlock.

The PCIe interrupt control unit 312 brings a thread of the end point 35 into a connected state, that is, makes the end point 35 connected (Step S1).

The GPIO 36 receives a PCIe reset signal output from the platform 10 (Step S2).

The GPIO 36 outputs an external interrupt signal to the external interrupt control unit 311 (Step S3).

The external interrupt control unit 311 inhibits external interrupt processing (Step S4).

The external interrupt control unit 311 clears the external interrupt processing (Step S5).

The GPIO 36 outputs a PCIe interrupt signal to the PCIe interrupt control unit 312 (Step S6). The PCIe interrupt signal is simply required to be output after the inhibition of the external interrupt signal described in Step S3. In other words, the PCIe interrupt signal may be output before clearing the external interruption. Alternatively, in place of the GPIO 36, the external interrupt control unit 311 may output the PCIe interrupt signal.

The PCIe interrupt control unit 312 issues a restart signal (Step S7). More specifically, the PCIe interrupt control unit 312 reinitializes the end point 35 connected to the initialized platform 10. Furthermore, the PCIe interrupt control unit 312 acquires transmission source information 351 from each of the end points 35. The PCIe interrupt control unit 312 identifies transmission source information 351 representing the platform 10 serving as a transmission source.

The PCIe interrupt control unit 312 outputs, to the PCIe state control unit 313, the transmission source information 351 representing the platform 10 serving as a transmission source that has transmitted data to the initialized platform 10 (Step S8).

The PCIe state control unit 313 determines whether or not the end point 35, which is connected to the platform 10 identified based on the transmission source information 351, has been in data communications (Step S9). The sequence diagram illustrates a case where the end point 35 has been in the data communications.

The PCIe state control unit 313 reinitializes the end point 35 corresponding to the platform 10 identified based on the transmission source information 351 (Step S10).

The PCIe state control unit 313 stops data transfer from the platform 10 identified based on the transmission source information 351 (Step S11). Specifically, the PCIe state control unit 313 stops DMA transfer from the platform 10 before the platform 10 serving as the transmission source falls into a deadlock.

The PCIe state control unit 313 brings a thread of the end point 35 into a not-connected state, that is, makes the thread of the end point 35 disconnected (Step S12). Subsequently, through usual processing, the thread of the end point 35 is shifted into a connected state, that is, made connected.

The distributed computer 1 completes initialization processing.

As described above, the distributed computer 1 according to one or more embodiments includes the platforms 10 and the relay device 30 communicably connecting the platforms 10. The relay device 30 includes: the end points 35; the processor 31 connected to the end points 35 over the internal bus 33 and the PCIe bus 34; and the GPIO 36 to receive a PCIe reset signal representing that the platform 10 has been initialized at a hardware level. In this configuration, when the platform 10 serving as the transmission destination is initialized during communications between the platforms 10, the processor 31 of the relay device 30 receives the PCIe reset signal via the GPIO 36. Then, the processor 31 initializes the end point 35 connected to the platform 10 serving as the transmission source from which data has been transmitted to the initialized platform 10. Before the platform 10 falls into a deadlock, the processor 31 initializes the end point 35 serving as the transmission source and stops DMA transfer. Therefore, the distributed computer 1 is able to prevent the platform 10 serving as the transmission source from falling into a deadlock due to a reboot.

In the above-described embodiment, while the PCIe is taken as an example of a bus (for example, an expansion bus) or an I/O interface for the units, the bus or the I/O interface is not limited to the PCIe. For example, the bus or the I/O interface for the units is simply required to be a technical means that is capable of performing data transfer between a device (a peripheral controller) and a processor by using a data transfer bus. The data transfer bus may be a general-purpose bus capable of performing data transfer at high speed under a local environment (for example, one system or one device) provided in one casing or the like. The I/O interface may be any one of a parallel interface and a serial interface.

In the case of serial transfer, the I/O interface is simply required to be an interface capable of performing point-to-point connection and performing data transfer on a packet basis. In the case of serial transfer, the I/O interface may have a plurality of lanes. A layered structure of the I/O interface may include a transaction layer to produce and decode a packet, a data link layer to perform error detection, and a physical layer to convert between serial transfer and parallel transfer. Furthermore, the I/O interface may include, for example, a root complex being at the top of a hierarchy and having one or more ports, an end point serving as an I/O device, a switch to increase a port, and a bridge to convert a protocol. The I/O interface may multiplex, by using a multiplexer, data and a clock signal which are to be transmitted, and may transmit data obtained by the multiplexer. In this case, a reception side may separate received data into the original data and the clock signal by using a demultiplexer.

Each of the computer programs 121 and 321 provided in the platforms 10 and the relay device 30, respectively, may be stored in a computer-readable storage medium, such as a CD-ROM, a CD-R, a memory card, a digital versatile disc (DVD), and a flexible disk (FD), as a file in an installable format or an executable format, and may be provided as a computer program product. Alternatively, each of the computer programs 121 and 321 may be stored on a computer connected to a network such as the Internet, and may be provided by being downloaded over the network. Alternatively, each of the computer programs 121 and 321 may be provided or distributed over network such as the Internet.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing system comprising:
a plurality of information processors; and
a relay device that communicably connects the information processors, wherein
each of the information processors comprises a first communication device that executes transmission of a reset signal representing that the corresponding information processor is initialized and executes transmission and reception of data, and
the relay device comprises:
a plurality of second communication devices each provided for a corresponding one of the information processors and each that executes reception of the reset signal and executes transmission and reception of the data;
a connection device that connects the second communication devices to enable the data to be transferred;
an input device that receives an input of the reset signal from each of the information processors with bypassing the second communication devices; and
a hardware processor that, when the input device receives the reset signal, executes initialization processing of initializing one of the second communication devices that corresponds to one of the information processors serving as a transmission source of the data, the initialization processing being executed on a condition that one of the information processors, from which the reset signal has been transmitted, receives the data via the connection device.

2. The information processing system according to claim 1, wherein the initialization processing executed by the hardware processor comprises processing of stopping the information processor serving as the transmission source from transmitting the data.

3. The information processing system according to claim 1, wherein the hardware processor is that inhibits external interruption when the input device receives the reset signal.

4. A relay device communicably connecting a plurality of information processors, the relay device comprising:
a plurality of second communication devices each provided for a corresponding one of the information processors and each that executes reception of a reset signal representing that the corresponding information processors is initialized and executes transmission and reception of data;
a connection device that connects the second communication devices to enable the data to be transferred;
an input device that receives an input of the reset signal from each of the information processors with bypassing the second communication devices; and
a hardware processor that, when the input device receives the reset signal, executes initialization processing of initializing one of the second communication devices that corresponds to one of the information processors serving as a transmission source of the data, the initialization processing being executed on a condition that one of the information processors, from which the reset signal has been transmitted, receives the data via the connection device.

5. A computer product comprising a non-transitory computer-readable recording medium on which an executable program is recorded, the program being executed by a computer as a relay device that comprises: a plurality of second communication devices each provided for a corresponding one of information processors and each that executes reception of the reset signal and executes transmission and reception of the data; a connection device that connects the second communication devices to enable the data to be transferred; and an input device that receives an input of the reset signal from each of the information processors with bypassing the second communication devices, the program instructing the computer to,
when the input device receives the reset signal, execute initialization processing of initializing one of the second communication devices that corresponds to one of the information processors serving as a transmission source of the data, the initialization processing being executed on a condition that one of the information processors, from which the reset signal has been transmitted, receives the data via the connection device.
